(19) United States
(12) Patent Application Publication
(10) Pub. No.: US 2024/0042872 A1
(43) Pub. Date: Feb. 8, 2024

(54) AC POWER GRID, SOCKET, AND METHOD FOR POWER DISTRIBUTION

(71) Applicant: Volkswagen Aktiengesellschaft, Wolfsburg (DE)

(72) Inventors: Daniel BAIER, Leiferde (DE); Bjoern-Erik BRANDT, Leiferde (DE); Florian QUANTMEYER, Wolfenbuettel (DE); Erik HAHN, Isenbuettel (DE); Henrik SCHWARZE, Magdeburg (DE)

(73) Assignee: Volkswagen Aktiengesellschaft, Wolfsburg (DE)

(21) Appl. No.: 18/230,983

(22) Filed: Aug. 7, 2023

(30) Foreign Application Priority Data
Aug. 8, 2022 (DE) 10 2022 208 225.7

(51) Int. Cl. B60L 50/51; B60L 53/16; H02J 3/32

(52) U.S. Cl. CPC B60L 50/51; B60L 53/16; H02J 3/32; B60L 2210/42; H02J 2310/48

(57) ABSTRACT

An AC power grid in an electric or hybrid vehicle, having an AC charging socket, at least one socket for an electrical load, and a bidirectional inverter. The bidirectional inverter is connected on the AC side to the AC charging socket and to the at least one socket and is connected on the DC side to a high-voltage battery of a traction network. At least one microprocessor and at least one switching element are associated with the socket. The microprocessor of the socket is connected to a control unit of the inverter via at least one communication line. Depending on a state, the control device generates a switching command for the at least one switching element of the socket.

This nonprovisional application claims priority under 35 U.S.C. § 119(a) to German Patent Application No. 10 2022 208 225.7, which was filed in Germany on Aug. 8, 2022, and which is herein incorporated by reference.

### BACKGROUND OF THE INVENTION

### Field of the Invention

The present invention relates to an AC power grid in an electric or hybrid vehicle, a socket, and a method for power distribution in an AC power grid in an electric or hybrid vehicle.

### Description of the Background Art

There is a growing need to provide a user of a motor vehicle with a socket for electrical loads.

A hybrid vehicle is known from DE 10 2019 127 032 A1, which corresponds to US 2020/0108819. And which has an electrical outlet having a socket and a controller programmed to receive a user-specified current limit for the socket and, as a response thereto, turning off the socket if the current limit is exceeded.

### SUMMARY OF THE INVENTION

It is therefore an object of the present invention to provide an improved AC power grid in an electric or hybrid vehicle, as well as providing a suitable socket and a method for power distribution.

In an example, the exemplary AC power grid in an electric or hybrid vehicle comprises an AC charging socket, at least one socket for an electrical load, and a bidirectional inverter, wherein the bidirectional inverter is connected on the AC side to the AC charging socket and to the at least one socket and is connected on the DC side to a high-voltage battery of a traction network, wherein at least one microprocessor and one switching element are associated with the socket, wherein the microprocessor of the socket is connected to a control unit of the inverter via at least one communication line, wherein depending on a state the control device generates a switching command for the at least one switching element of the socket. Energy can be distributed very flexibly by means of this AC power grid. Preferably, the microprocessor and the switching element are arranged in the socket. In this case, the socket can be arranged inside the motor vehicle or can also be arranged outside on the motor vehicle, wherein preferably at least one socket is arranged inside. The microprocessor and other sensors in the socket preferably receive their supply voltage from a low-voltage on-board electrical system. For example, if the AC charging socket is connected to an external AC charging infrastructure, the socket is supplied via this charging voltage. Otherwise, the socket is supplied with voltage from the high-voltage battery via the inverter.

The state as a function of which the at least one switching element can be switched is, for example, at least one of the following states: detection of a plugged load in the socket, state of charge of the high-voltage battery, power consumption of the plugged load, temperature of the socket, and/or detection of a charging infrastructure at the AC charging socket or at another charging socket of the motor vehicle.

Thus, the switching element may only be closed if an electrical load is plugged into the socket at all. Alternatively, or in addition, the switching element is switched depending on the state of charge (SOC State of Charge) of the high-voltage battery, in particular if the socket is supplied from the high-voltage battery via the inverter. In this regard, at least one limit value for the state of charge can be provided, below which the switching element is opened to prevent a deep discharge of the high-voltage battery. Alternatively, or in addition, the state can be the power consumption of the plugged load. In this regard, at least one limit value for the power consumption can be provided, above which the switching element is opened. In this case, the limit value can also be dependent on other states. Alternatively, or in addition, a state can also be whether a charging infrastructure is detected at the AC charging socket or at another charging socket (e.g., DC charging socket) of the motor vehicle.

The socket can have a country coding, wherein the socket is designed to transmit the country coding to the control unit of the inverter. In this case, the country coding can be designed as hardware or software coding. Depending on the country coding, the control unit can then set the frequencies and voltage levels at the AC outlet of the inverter.

The AC charging socket can be directly connected to the socket.

The socket can be connected only to the inverter. The advantage of this embodiment is that switching off or de-energizing the AC charging socket is simplified, for example, in order to de-energize the AC charging socket during driving.

The socket can have a current sensor and/or a temperature sensor and/or a status light. The status light is designed as an LED, for example, and lights up when the switching element is closed.

The AC power grid can have at least two sockets, wherein one socket is designed as a master and the other socket as a slave. This can reduce the circuitry costs for the slaves. Preferably, all slaves are switched on or off centrally via the master.

The AC power grid can be designed to permanently close the switching element in a camper mode, wherein the control unit of the inverter is switched to a sleep mode. Thus, the socket can be supplied via shore power, wherein the motor vehicle sleeps and consumes almost no energy. Shore power is provided at campgrounds via an appropriate infrastructure.

The socket for an AC power grid has at least one microprocessor and one switching element, wherein the microprocessor has a communication interface, wherein the socket is configured to transmit a state via the communication interface. The communication interface is preferably designed as a bus interface, for example, as a LIN bus interface. With respect to the further embodiments, reference is made to the entire contents of the preceding statements.

The method of power distribution in an AC power grid in an electric or hybrid vehicle, wherein the AC power grid has an AC charging socket, at least one socket for an electrical load, and a bidirectional inverter, wherein the inverter is connected on the AC side to the AC charging socket and to the at least one socket and is connected on the DC side to a high-voltage battery of a traction network, wherein a microprocessor and at least one switching element are associated with the socket, wherein the microprocessor of the socket is connected to a control unit of the inverter via at least one communication line, is characterized by the method steps that depending on a state the control unit generates a switching command for the at least one switching element of the socket and transmits it to the microprocessor which then controls the at least one switching element. With regard to the further design, reference is made to the entire contents of the preceding statements.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic block diagram of an AC power grid;

FIG. 2 is a schematic block diagram of a socket;

FIG. 3 is a schematic block diagram of an AC power grid in an alternative embodiment; and

FIG. 4 is a schematic block diagram of a socket arrangement with a central control unit.

### DETAILED DESCRIPTION

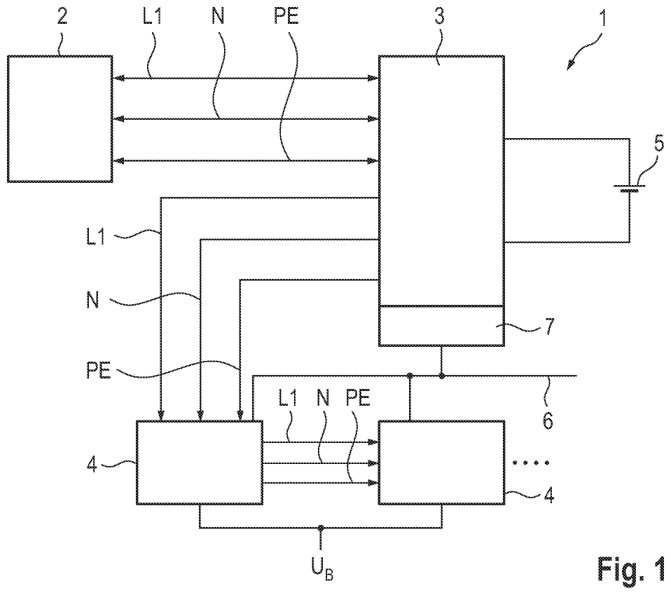

An AC power grid 1 is shown schematically in FIG. 1 comprising an AC charging socket 2, a bidirectional inverter 3, and two sockets 4. Bidirectional inverter 3 is connected on the DC side to a high-voltage battery 5 of a traction network of an electric or hybrid vehicle. On the AC side, bidirectional inverter 3 is connected to the AC charging socket 2 and to a socket 4. It is further shown here that the connection comprises a phase line L1, a neutral conductor N, and a protective conductor PE. In reality, there are additional phases and control lines between AC charging socket 2 and bidirectional inverter 3, but because only one phase is routed to socket 4, the illustration is limited. A microprocessor with sensors is arranged in each case in sockets 4, which will be explained in more detail later, wherein the supply voltage U_{B} for the microprocessors and the sensors comes from a low-voltage on-board electrical system. At least one switching element, by means of which phase line L1 can be switched, is arranged at least in the first socket 4. In addition, the neutral conductor N can also be switched. Here, the double arrows indicate that inverter 3 can also feed power back into the external AC grid, but this is not required. It is further shown that the phase L1, the neutral conductor N, and the protective conductor PE are looped through one socket 4 to the other socket. Sockets 4 are connected to a control unit 7 of inverter 3 via a communication line 6, which is designed as a LIN bus, for example.

By means of this AC power grid 1, sockets 4 can now be supplied differently in different situations, wherein they can be switched off via the switching element in the event of a fault and in certain situations. In this case, preferably, at least one socket 4 is arranged inside the motor vehicle. When AC charging socket 2 is connected to an external charging infrastructure by means of a charging plug, high-voltage battery 5 is charged via inverter 3. In this case, a phase line L1, the neutral conductor N, and the protective conductor PE in inverter 3 can be looped through directly to socket 4. Alternatively, it can also be provided that separate lines are provided, wherein inverter 3 generates the voltage signals for the phase line L1 for socket 4 by converting a DC voltage. The latter is somewhat worse in terms of energy, but all phase lines are equally loaded. If, in contrast, there is no charging plug in AC charging socket 2, socket 4 is supplied from high-voltage battery 5 via inverter 3, which can also be done while driving or if high-voltage battery 5 is charged by means of DC voltage. A limit value for the state of charge of high-voltage battery 5 can be specified, particularly in the driving mode but also when the vehicle is stationary, wherein sockets 4 are switched off via the switching elements if the value falls below this limit value. A camper mode is also provided, which can be activated via a display and control panel, for example. In this case, sockets 4 are supplied with shore power via the AC charging socket 2, wherein inverter 3 permanently switches through the switching elements of sockets 4 and then enters a sleep mode, wherein the electrical energy is looped through inverter 3 to sockets 4.

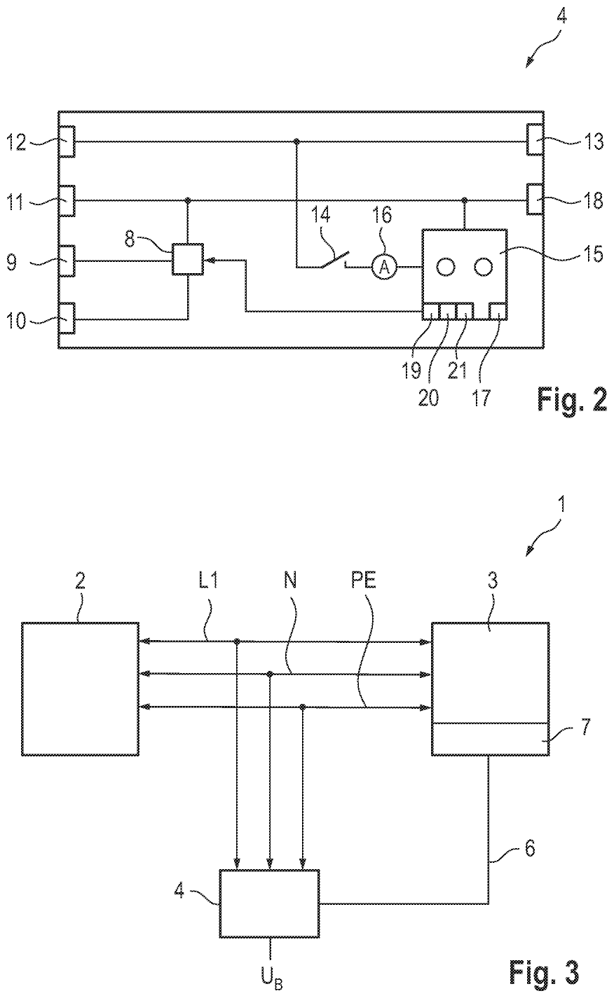

FIG. 2 schematically shows a block diagram of a socket 4. Socket 4 has a microprocessor 8 connected to a communication interface 9 through which socket 4 communicates with inverter 3, for example, via a LIN bus. Further, microprocessor 8 is connected to a hardware coding 10 by means of which a unique address is assigned to socket 4 (e.g., a LIN address). Further, socket 4 has an interface 11 for the supply voltage U_{B}. The phase line L1 is then connected to an AC voltage input 12, which is looped through to an AC voltage outlet 13, on the one hand, and via a switching element 14 to a receptacle 15, on the other, into which an electrical load can then be plugged with its plug. For reasons of clarity, the neutral conductor N and the protective conductor PE (see FIG. 1) are not shown.

A current sensor 16 is arranged between switching element 14 and receptacle 15. An LED 17 is arranged on receptacle 15 as a status light, which visually signals the switching state of switching element 14, wherein switching element 14 is formed, for example, as a relay or power transistor. A switching element can also be arranged in the line for the neutral conductor N, but this is not required. LED 17 also receives the power supply via interface 11, wherein the voltage supply U_{B} like the AC voltage is looped through to an outlet 18 so that it is available for another socket 4. Further, a temperature sensor 19, a country coding 20, and a sensor 21 for detecting a plugged load are arranged on receptacle 15, which is designed as a limit switch, for example. Temperature sensor 19, country coding 20, and sensor 21 are connected to microprocessor 8 using data technology. These data are transmitted by microprocessor 8 to control unit 7 of inverter 3, which can then adjust the frequency and voltage amplitude accordingly to the country coding. Current sensor 16 can then be used to determine the power consumption of a plugged-in consumer. In this case, inverter 3 can specify a maximum power consumption; when this is exceeded, socket 4 is switched off by switching element 14. In this case, the limit value for the maximum power consumption can be adjusted depending on other parameters (e.g., SOC of high-voltage battery 5). With regard to the temperature, microprocessor 8 can also autonomously actuate switching element 14 if, for example, a limit value for the temperature is exceeded. Preferably, switching element 14 is open when sensor 21 does not detect an extended load.

Inverter 3 or control unit 7 of inverter 3 can thus control a targeted power distribution and switch sockets 4 on or off depending on the state.

Further, sockets 4 can also be connected in a master-slave configuration, wherein a microprocessor 8 and the switching element or elements 14 are arranged in only one socket 4, wherein the slaves transmit their sensor signals to the master. The advantage is the low circuitry cost for the slaves, wherein, however, sockets 4 can only be switched on or off in their entirety.

An alternative embodiment for the AC power grid 1 is shown in FIG. 3, wherein only one socket 4 is shown, which is directly connected to the AC charging socket 2. In this case, switching elements can be placed in AC charging socket 2 in order to de-energize AC charging socket 2 during driving, although sockets 4 are supplied with voltage via inverter 3.

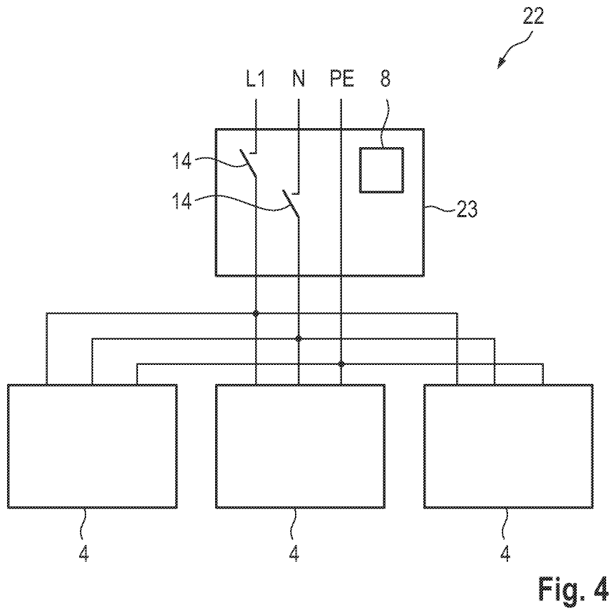

Further, an alternative socket arrangement 22 that is similar to the master-slave arrangement is shown in FIG. 4, wherein, however, microprocessor 8 and switching elements 14 are arranged in a separate central control unit 23, wherein control unit 23 is associated with sockets 4. The other sensors, such as, for example, current sensor 16, temperature sensor 19, country coding 20, and sensor 21, can then be arranged locally in sockets 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An AC power grid in an electric or hybrid vehicle, the AC power grid comprising:
an AC charging socket;
at least one socket for an electrical load; and
a bidirectional inverter connected on an AC side to the AC charging socket and to the at least one socket and is connected on a DC side to a high-voltage battery of a traction network; and
at least one microprocessor and one switching element being associated with the socket,
wherein the microprocessor of the socket is connected to a control unit of the inverter via at least one communication line, and
wherein, depending on a state, the control unit generates a switching command for the at least one switching element of the socket.

2. The AC power grid according to claim 1, wherein the state is at least one of the following states:
a detection of a plugged load in the socket;
a state of charge of the high-voltage battery;
a power consumption of the plugged load;
a temperature of the socket; and/or
a detection of a charging infrastructure at the AC charging socket or at another charging socket of the motor vehicle.

3. The AC power grid according to claim 1, wherein the socket has a country coding, and wherein the socket is designed to transmit the country coding to the control unit of the inverter.

4. The AC power grid according to claim 1, wherein the AC charging socket is directly connected to the socket.

5. The AC power grid according to claim 1, wherein the socket is connected only to the inverter.

6. The AC power grid according to claim 1, wherein the socket has a current sensor and/or a temperature sensor and/or a status light.

7. The AC power grid according to claim 1, wherein at least two sockets are present, wherein one socket is designed as a master and the other socket(s) are designed as slaves.

8. The AC power grid according to claim 1, wherein the AC power grid is designed to permanently close the switching element in a computer mode, and wherein the control unit of the inverter is switched to a sleep mode.

9. A socket for an AC power grid, the socket comprising:
at least one microprocessor and at least one switching element arranged in the socket; and
a communication interface in the microprocessor,
wherein the socket is configured to transmit a state via the communication interface.

10. A method for power distribution in an AC power grid in an electric or hybrid vehicle, the method comprising:
providing the AC power grid with an AC charging socket, at least one socket for an electrical load, and a bidirectional inverter;
connecting the bidirectional inverter on an AC side to the AC charging socket and to the at least one socket; and
connecting the bidirectional inverter on a DC side to a high-voltage battery of a traction network;
associating at least one microprocessor and one switching element with the socket;
connecting the microprocessor of the socket to a control unit of the inverter via at least one communication line;
generating a switching command based on a state of the control unit; and
transmitting the switching command to the microprocessor, which controls the at least one switching element of the socket based on the transmitted switching command.
